(19) United States
(12) Patent Application Publication
(10) Pub. No.: US 2019/0163476 A1
(43) Pub. Date: May 30, 2019

(54) SYSTEMS, METHODS, AND APPARATUSES HANDLING HALF-PRECISION OPERANDS

(71) Applicant: Intel Corporation, Santa Clara, CA (US)

(72) Inventors: Robert VALENTINE, Kiryat Tivon (IL); Mark J. CHARNEY, Lexington, MA (US); Raanan SADE, Kibutz Sarid (IL); Elmoustapha OULD-AHMED-VALL, Chandler, AZ (US); Jesus CORBAL, King City, OR (US)

(21) Appl. No.: 15/824,902

(22) Filed: Nov. 28, 2017

(51) Int. Cl. G06F 9/30

(52) U.S. Cl. CPC G06F 9/30036; G06F 9/30018; G06F 9/30014; G06F 9/3016; G06F 9/30109; G06F 9/3013

(57) ABSTRACT

Implementations detailed herein included, but are not limited to, an apparatus having instruction execution circuitry to execute a decoded instruction having at least one operand utilizing half-precision floating point data and a register to store control information about the at least one operand utilizing half-precision floating point data, wherein the control information is to dictate when underflowing operations of execution of the instruction are to be flushed to zero and when denormal inputs of the instruction are to be zeroed.

### FIELD OF INVENTION

The field of invention relates generally to computer processor architecture, and, more specifically, to processing using half-precision floating-point (FP16) values.

### BACKGROUND

There are many different data types that may be utilized by processors. These include scalar values and floating-point values. Some processors operate on multiple floating-point data types: half-precision floating-point, single-precision floating-point, double-precision floating-point, and double-extended precision floating-point. In most instances, the data formats for these data types correspond directly to formats specified in the Institute for Electrical and Electronics (IEEE) Standard 754 for Binary Floating-Point Arithmetic.

### BRIEF DESCRIPTION OF THE DRAWINGS

The present invention is illustrated by way of example and not limitation in the figures of the accompanying drawings, in which like references indicate similar elements and in which:

FIG. 1(A) illustrates an embodiment of a control and status register having fields related to half-precision floating-point.

FIG. 1(B) illustrates an embodiment of a control and status register having fields related to half-precision floating-point.

FIG. 2 illustrates an embodiment of an apparatus for execution of an instruction with denormal input half-precision data elements.

FIG. 3 illustrates an embodiment of an apparatus for execution of an instruction with underflow results using half-precision data elements.

FIG. 4 illustrates an embodiment of an apparatus for execution of an instruction with denormal inputs and underflow results using half-precision data elements.

FIG. 5 illustrates an embodiment of a method for processing an instruction having half-precision data.

FIG. 6 is a block diagram of a register architecture according to one embodiment of the invention;

FIG. 7(A) is a block diagram illustrating both an exemplary in-order pipeline and an exemplary register renaming, out-of-order issue/execution pipeline according to embodiments of the invention;

FIG. 7(B) is a block diagram illustrating both an exemplary embodiment of an in-order architecture core and an exemplary register renaming, out-of-order issue/execution architecture core to be included in a processor according to embodiments of the invention;

FIGS. 8A-B illustrate a block diagram of a more specific exemplary in-order core architecture, which core would be one of several logic blocks (including other cores of the same type and/or different types) in a chip;

FIG. 9 is a block diagram of a processor that may have more than one core, may have an integrated memory controller, and may have integrated graphics according to embodiments of the invention;

FIGS. 10-13 are block diagrams of exemplary computer architectures; and

FIG. 14 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A variety of real numbers and special values can be encoded in the IEEE Standard 754 floating-point format. These numbers and values are generally divided into the following classes: signed zeros, denormalized finite numbers, normalized finite numbers, signed infinities, not a numbers (NaNs), and indefinite numbers. Encodings of these numbers include a sign bit, biased exponent, and significand. When the biased exponent is zero, smaller numbers can only be represented by making the integer bit (and perhaps other leading bits) of the significand zero. The numbers in this range are deformalized numbers. The use of leading zeros with denormalized numbers allows smaller numbers to be represented. However, this denormalization may cause a loss of precision (the number of significant bits is reduced by the leading zeros).

When performing normalized floating-point computations, embodiments of the processor detailed here normally operate on normalized numbers and produce normalized numbers as results. Denormalized numbers represent an underflow condition.

Detailed herein are embodiments of processors that support separate denormal controls for FP16 operations through the use of one or more bits of one or more registers (e.g., flags of a control and status register). Unfortunately, not all processors that support FP16 facilitate using the full dynamic range of the FP16 numbers which embodiments detailed here do.

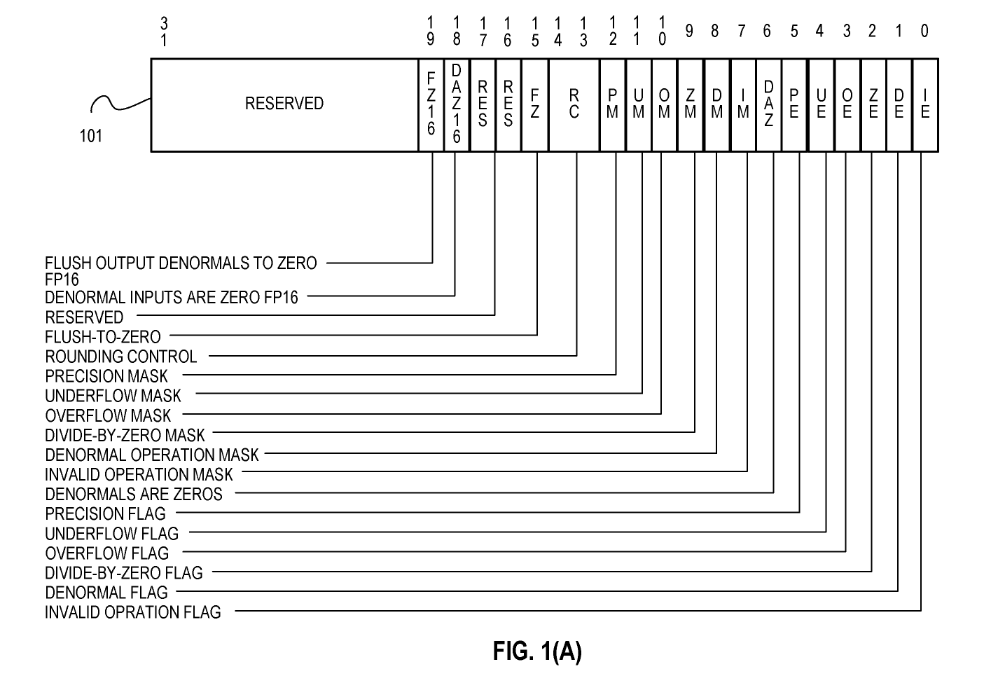

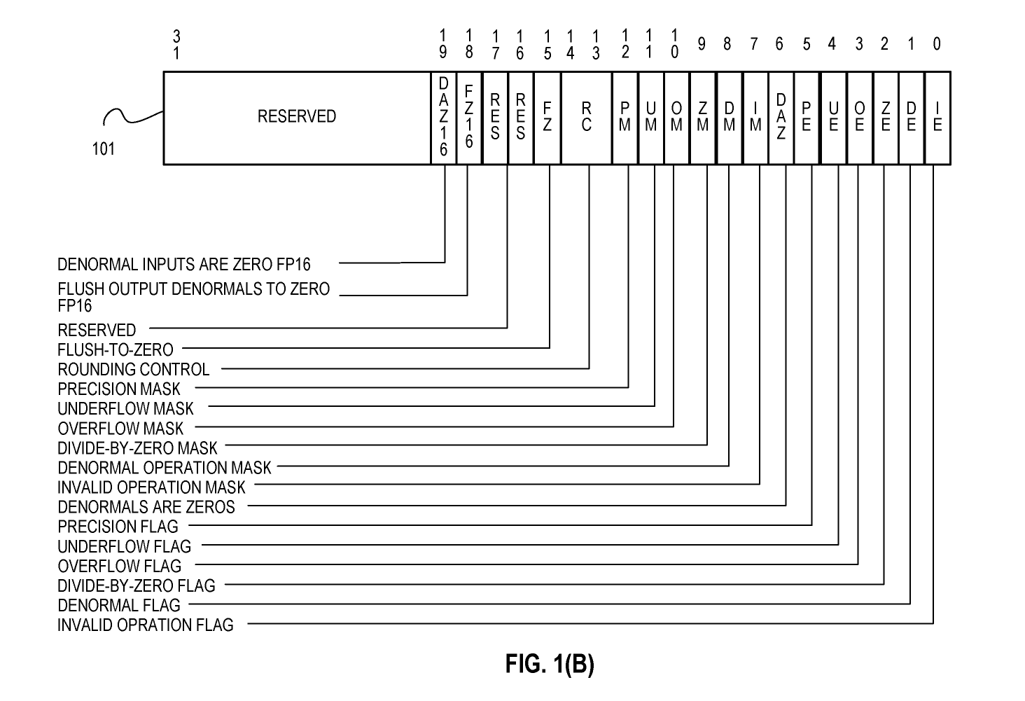

FIG. 1(A) illustrates an embodiment of a control and status register having fields related to half-precision floating-point usage for an instruction. As shown, two bits (fields) of the control and status register 101 are used to control denormal number handling for FP16 operations. Bit 18, denormals-are-zero FP16 (DAZ16), when set, indicates that input FP16 denormal elements of operands are to be treated as zero for computations (denormals-as-zero mode for FP16). For example, each denormal input element is set to zero before the operation of the instruction is performed. In some embodiments, the zeroed elements have the same sign as the denormal input.

The denormals-are-zeros FP16 mode is not compatible with the IEEE Standard 754. However, the denormals-are-zeros FP16 mode improves processor performance for applications such as streaming media processing, where rounding a denormal operand to zero does not appreciably affect the quality of the processed data.

Bit 19, FZ16, when set, indicates that output FP16 denormal element results are flushed to zero (flush-to-zeros mode for FP16). For example, underflow results are set to zero after the operation of the instruction is performed.

Typically, when an instruction uses an FP16 value in a source operand DAZ16 is used and when an instruction produces an FP16 output FZ16 is used. Note that both bits may be used in some embodiments.

Several other bits of the control and status register may be used for other operations. For example, bits 0 through 5 indicate exceptions that have been detected (e.g., precision, underflow, overflow, divide-by-zero, denormal, and invalid operation). Bits 7 through 12 provide mask bits for exception types (e.g., invalid operation mask, denormal operation mask, divide-by-zero mask, overflow mask, underflow mask, and precision mask). Bits 13 and 14 control how results of floating-point instructions are rounded. Bits 6 and 15 enable denormals-are-zeros and flush-to-zeros mode for non-FP16 data.

When one or more floating-point exception conditions are detected, the processor sets the appropriate flag bits, then takes one of two possible courses of action, depending on the settings of the corresponding mask bits: 1) mask bit set—the processor handles the exception automatically, producing a predefined (and often times usable) result, while allowing program execution to continue undisturbed; and 2) mask bit clear—the processor invokes a software exception handler to handle the exception.

FIG. 1(B) illustrates an embodiment of a control and status register having fields related to half-precision floating-point usage for an instruction. As shown, two bits of the control and status register 101 are used to control denormal number handling for FP16 operations. Bit 19, denormals-are-zero FP16 (DAZ16), when set, indicates that input FP16 denormal elements of operands are to be treated as zero for computations (denormals-as-zero mode for FP16). For example, each denormal input element is set to zero before the operation of the instruction is performed. In some embodiments, the zeroed elements have the same sign as the denormal input.

The denormals-are-zeros FP16 mode is not compatible with the IEEE Standard 754. However, the denormals-are-zeros FP16 mode improves processor performance for applications such as streaming media processing, where rounding a denormal operand to zero does not appreciably affect the quality of the processed data.

Bit 18, FZ16, when set, indicates that output FP16 denormal element results are flushed to zero (flush-to-zeros mode for FP16). For example, underflow results are set to zero after the operation of the instruction is performed.

Typically, when an instruction uses an FP16 value in a source operand DAZ16 is used and when an instruction produces an FP16 output FZ16 is used. Note that both bits may be used in some embodiments.

Several other bits of the control and status register may be used for other operations. For example, bits 0 through 5 indicate exceptions that have been detected (e.g., precision, underflow, overflow, divide-by-zero, denormal, and invalid operation). Bits 7 through 12 provide mask bits for exception types (e.g., invalid operation mask, denormal operation mask, divide-by-zero mask, overflow mask, underflow mask, and precision mask). Bits 13 and 14 control how results of floating-point instructions are rounded. Bits 6 and 15 enable denormals-are-zeros and flush-to-zeros mode for non-FP16 data.

When one or more floating-point exception conditions are detected, the processor sets the appropriate flag bits, then takes one of two possible courses of action, depending on the settings of the corresponding mask bits: 1) mask bit set—the processor handles the exception automatically, producing a predefined (and often times usable) result, while allowing program execution to continue undisturbed; and 2) mask bit clear—the processor invokes a software exception handler to handle the exception.

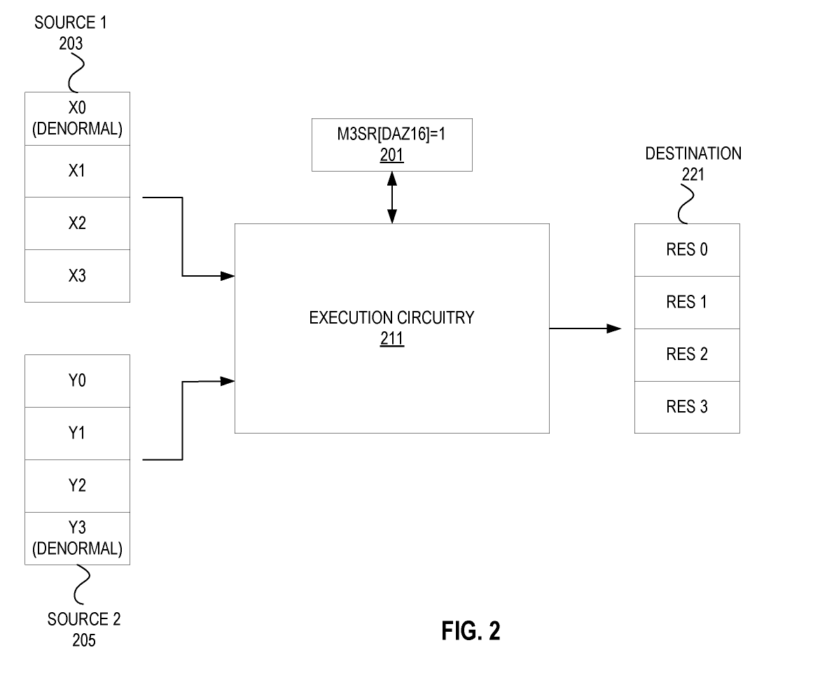

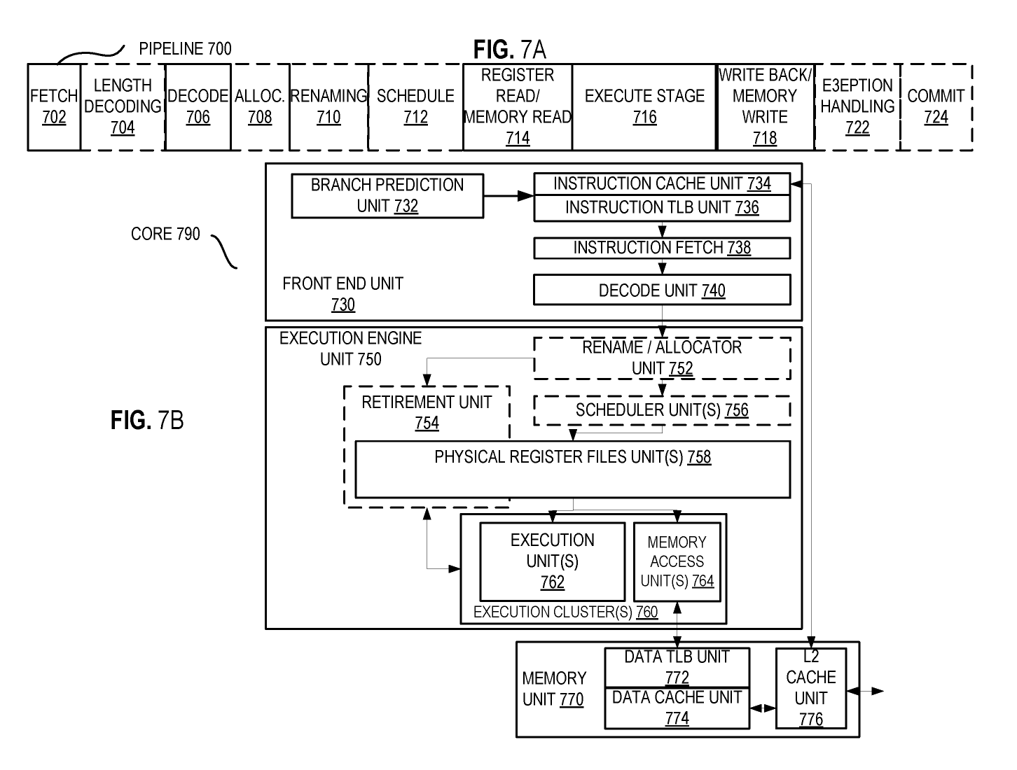

FIG. 2 illustrates an embodiment of a processor core for execution of an instruction with denormal input half-precision data elements. In this embodiment, some aspects of the processor core are not shown in the interest of a compact description (for example, an instruction decoder, etc. is not shown). Examples of these aspects are found in other figures such as FIGS. 7(A) and (B).

In this example, packed data source 1 203 (e.g., a memory location, or a vector/single, instruction multiple data (SIMD) register) and packed data source 2 205 (e.g., a memory location, or a vector/single, instruction multiple data (SIMD) register) each include one packed data element position (X0 and Y3) that is a denormal value. As illustrated, the denormals-are-zero FP16 bit is set in the control and status register 201. For example, bit 18 of FIG. 1(A) is set. The execution circuitry 211 reads this status register 201 and treats each denormal packed data element as zero for the operation(s) to be performed in accordance with the instruction being executed.

The result(s) of the operation(s) performed by the execution circuitry 211 are stored in a destination 221 (e.g., a memory location, or a vector/single, instruction multiple data (SIMD) register). For example, when the operations are per packed data element multiplications, the data elements for packed data element positions 0 and 3 of the destination will both be zero due to the multiplication by zero.

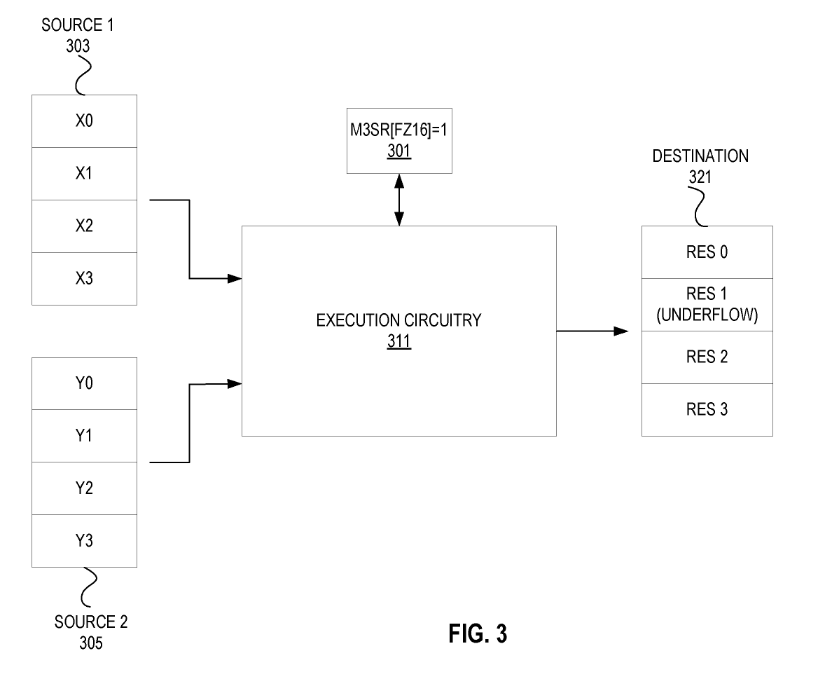

FIG. 3 illustrates an embodiment of an apparatus for execution of an instruction with underflow results using half-precision data elements. In this embodiment, some aspects of the processor core are not shown in the interest of a compact description (for example, an instruction decoder, etc. is not shown). Examples of these aspects are found in other figures such as FIGS. 7(A) and (B).

In this example, packed data source 1 303 (e.g., a memory location, or a vector/single, instruction multiple data (SIMD) register) and packed data source 2 305 (e.g., a memory location, or a vector/single, instruction multiple data (SIMD) register) each include four packed data element positions. As illustrated, the flush denormal output to zero FP16 bit is set in the control and status register 301. For example, bit 19 of FIG. 1(A) is set. The execution circuitry 311 reads this register 301 and, for each underflow packed data element result, returns a zero result with the sign of the true result. Additionally, in some embodiments, the precision and underflow exception flags of the control and status register are set.

The result(s) of the operation(s) performed by the execution circuitry 311 are stored in a destination 321 (e.g., a memory location, or a vector/single, instruction multiple data (SIMD) register). In this example, packed data element position 1 of the destination 321 resulted in an underflow. Stored in this packed data element position is a zero result with the sign of the true result.

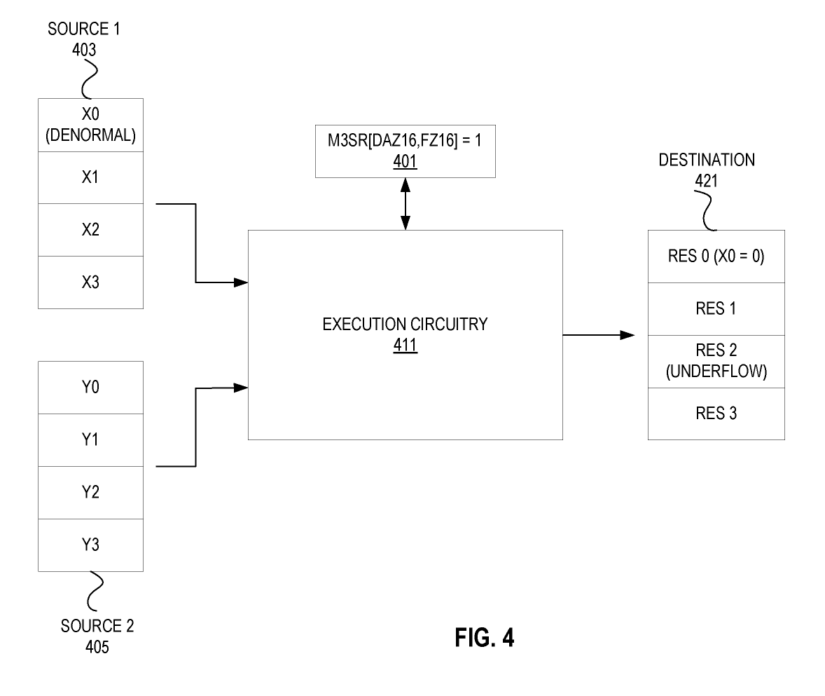

FIG. 4 illustrates an embodiment of an apparatus for execution of an instruction with denormal inputs and underflow results using half-precision data elements. In this embodiment, some aspects of the processor core are not shown in the interest of a compact description (for example, an instruction decoder, etc. is not shown). Examples of these aspects are found in other figures such as FIGS. 7(A) and (B).

In this example, packed data source 1 403 (e.g., a memory location, or a vector/single, instruction multiple data (SIMD) register) and packed data source 2 405 (e.g., a memory location, or a vector/single, instruction multiple data (SIMD) register) each include one packed data element position (X0 and Y3) that is a denormal value. As illustrated, the denormals-are-zero FP16 bit and flush denormal to zero bits are set in the control and status register 401. For example, bits 18 and 19 of FIG. 1(A) are set. The execution circuitry 411 reads this status register 401 and treats each denormal packed data element as zero for the operation(s) to be performed in accordance with the instruction being executed, and, for each underflow packed data element result, returns a zero result with the sign of the true result.

The result(s) of the operation(s) performed by the execution circuitry 411 are stored in a destination 421 (e.g., a memory location, or a vector/single, instruction multiple data (SIMD) register). As shown, there is both an underflow and a result calculated using a zero.

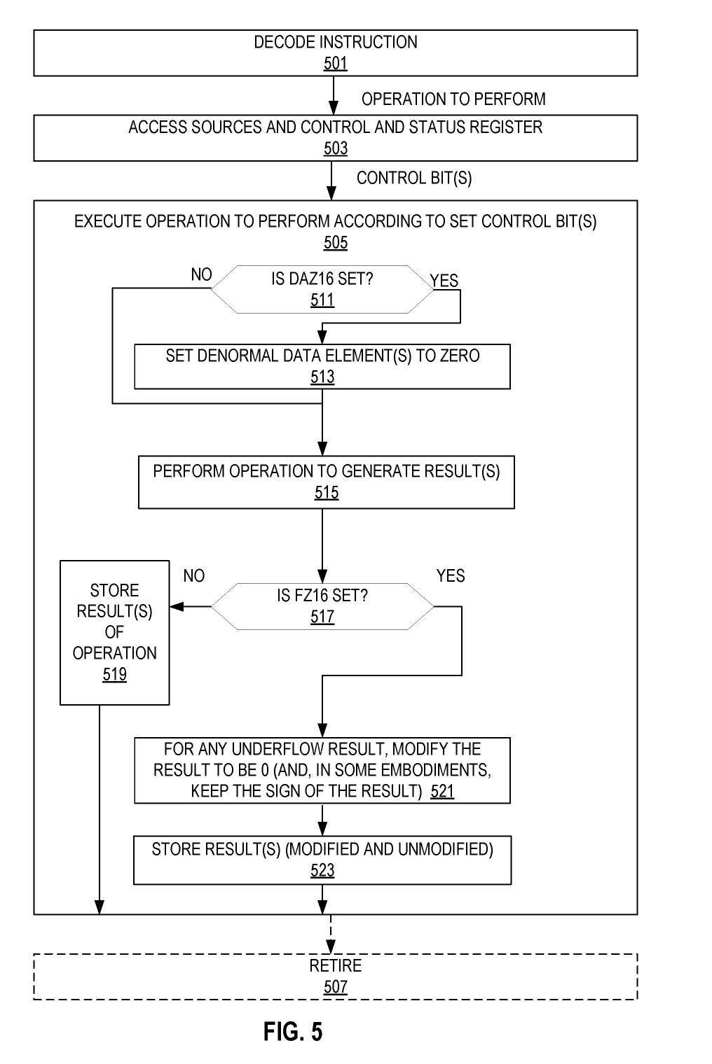

FIG. 5 illustrates an embodiment of a method for processing an instruction having half-precision data. At 501, the instruction is decoded. For example, decode unit circuitry 740 of FIG. 7(B) decodes the instruction. The decoded instruction provides one or more operations to perform on packed data source operands having FP16 packed data elements of the instruction.

At 503, the control and status register for the processor (or processor core) and the source locations (e.g., register(s) and/or memory) is accessed. For example, execution circuitry such as execution unit(s) 762 access the control and status register which is typically a part of a physical register file. Note that the control and status register is typically set with a restore instruction (e.g., FXRSTOR) or a load control and status register instruction (e.g., LDM3SR).

The control bit(s) is/are used by the execution circuitry to execute the operation(s) to perform at 505. At 511, a determination of if the denormals-are-zero FP16 bit of the control bit(s) is set is made. When the denormals-are-zero FP16 bit is set, then any denormal packed data elements of the source(s) are set to zero at 513. When the denormals-are-zero FP16 bit is not set, then any denormal packed data elements of the source(s) are used as is.

The operation(s) of the instruction is/are performed to generate one or more results at 515.

At 517, a determination of if the flush denormals to zero FP16 bit is set is made. When it is not, then the result(s) of the operation(s) is/are stored in the destination of the instruction at 519.

When the flush denormals to zero FP16 bit is set, then for any underflow result that result is set to be zero at 521. Additionally, in some embodiments, the sign of the true result is kept. The modified and unmodified results of the operation are then stored at 523.

Finally, in some embodiments, the instruction is retired and committed at 507.

Note that the determinations of 511 and 517 may be performed in parallel or in the opposite order.

Detailed below are exemplary architectures and systems that may be utilized for the above detailed instructions. For example, an exemplary pipeline supporting the instructions is detailed that includes circuitry to perform the methods detailed herein.

Exemplary Register Architecture

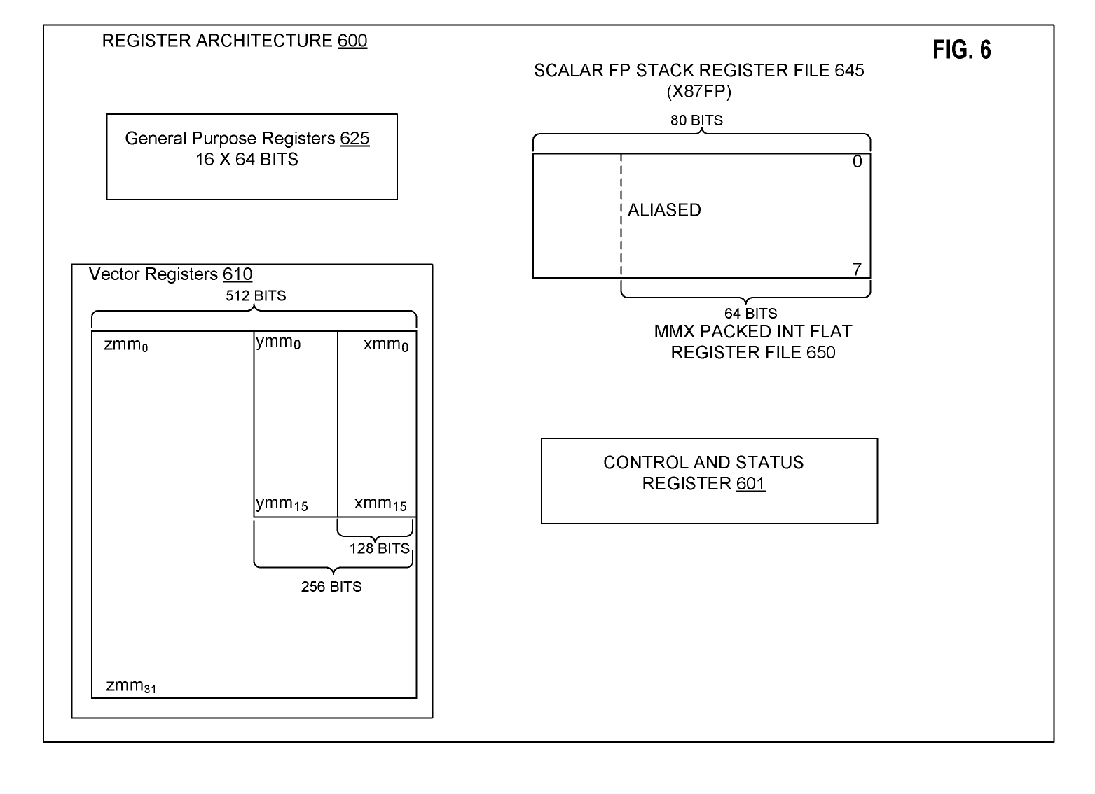

FIG. 6 is a block diagram of a register architecture 600 according to one embodiment of the invention.

As shown a control and status register 601 is provided as detailed above.

In the embodiment illustrated, there are 32 vector registers 610 that are 512 bits wide; these registers are referenced as zmm0 through zmm31. The lower order 256 bits of the lower 9 zmm registers are overlaid on registers ymm0-15. The lower order 128 bits of the lower 9 zmm registers (the lower order 128 bits of the ymm registers) are overlaid on registers xmm0-15.

General-purpose registers 625—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 645, on which is aliased the MMX packed integer flat register file 650—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures. Detailed herein are circuits (units) that comprise exemplary cores, processors, etc.

Exemplary Core Architectures

In-Order and Out-of-Order Core Block Diagram

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows circuitry of a processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, control and status (e.g., an instruction pointer that is the address of the next instruction to be executed and/or a control and status register), etc. In one embodiment, the physical register file(s) unit 758 comprises a vector registers unit and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

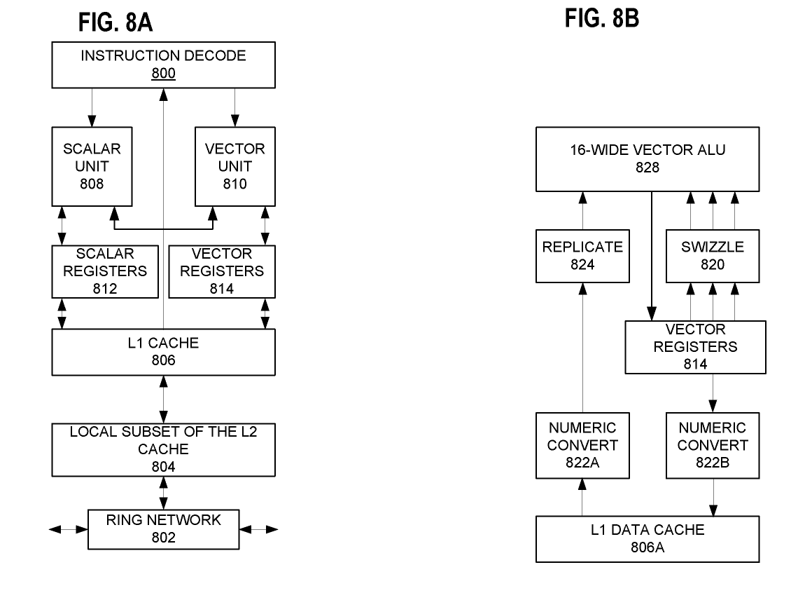

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. Each ring data-path is 1024-bits wide per direction in some embodiments.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 9-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input.

Processor with Integrated Memory Controller and Graphics

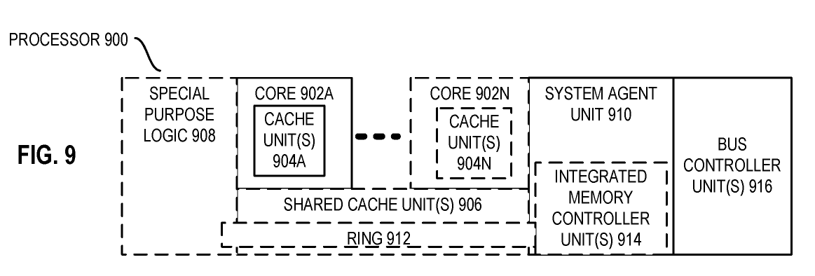

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores 904A-N, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902-A-N.

In some embodiments, one or more of the cores 902A-N are capable of multithreading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

Exemplary Computer Architectures

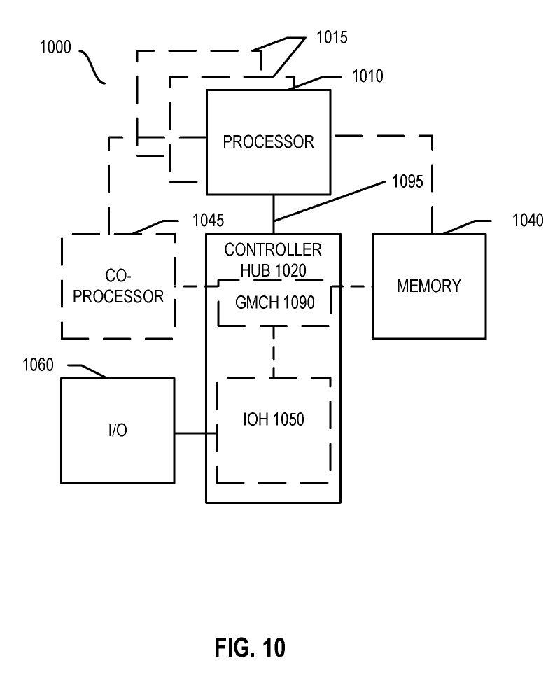

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment, the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface, or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

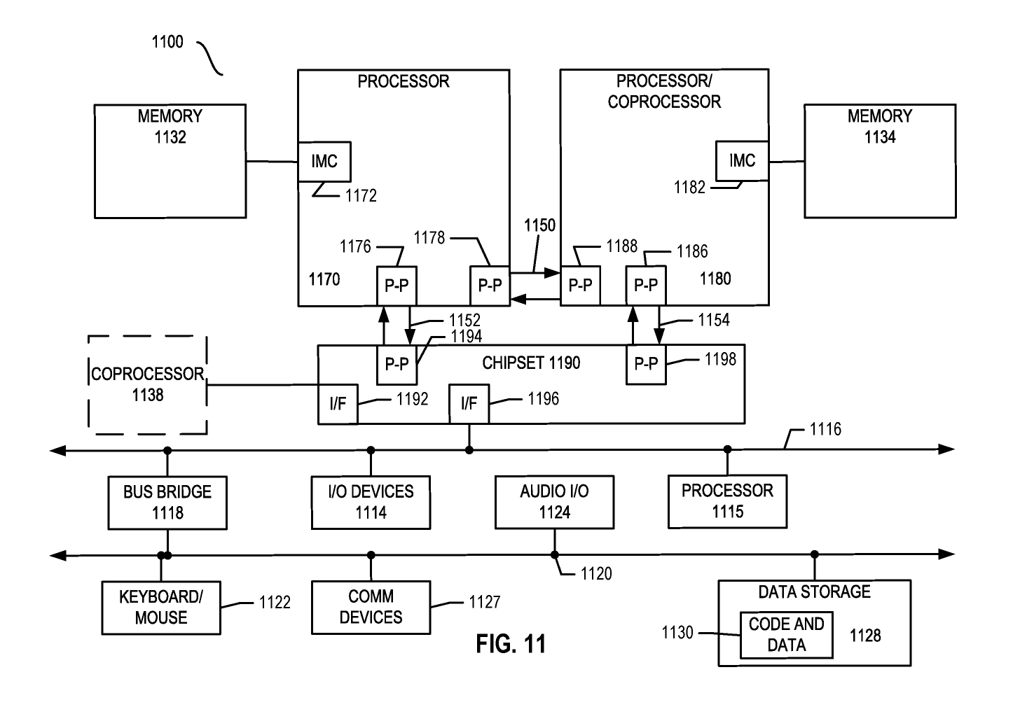

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1192. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1116. Note that other architectures are possible. For example, instead of the point-to-point architecture of FIG. 11, a system may implement a multi-drop bus or other such architecture.

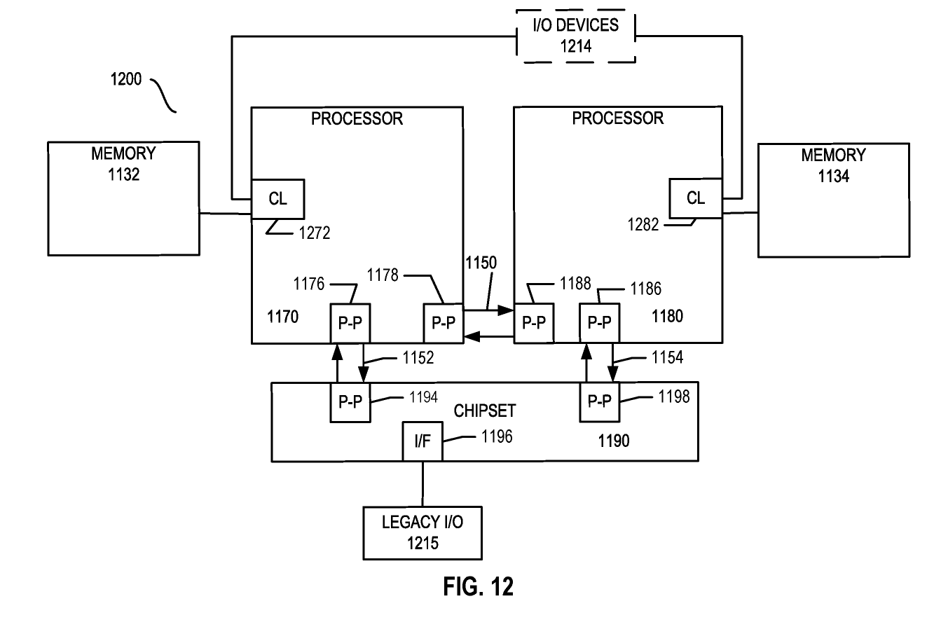

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1272 and 1282, respectively. Thus, the CL 1272, 1282 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

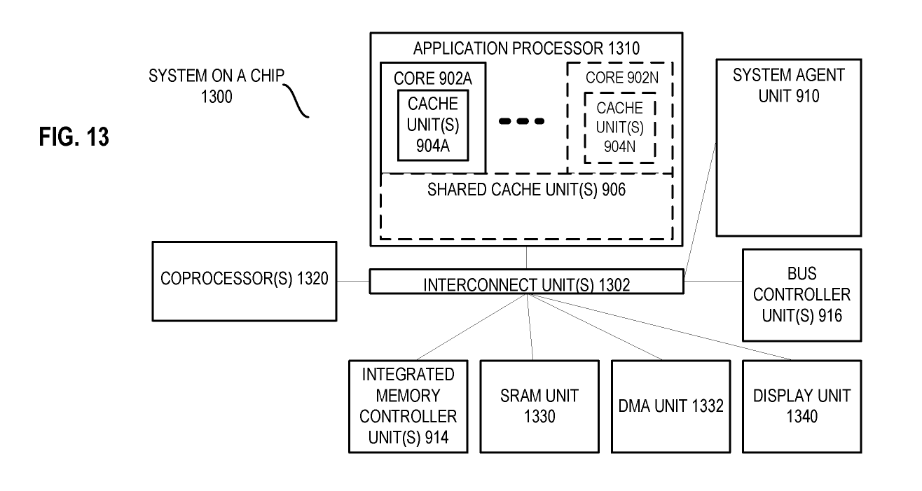

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 132A-N, cache units 904A-N, and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

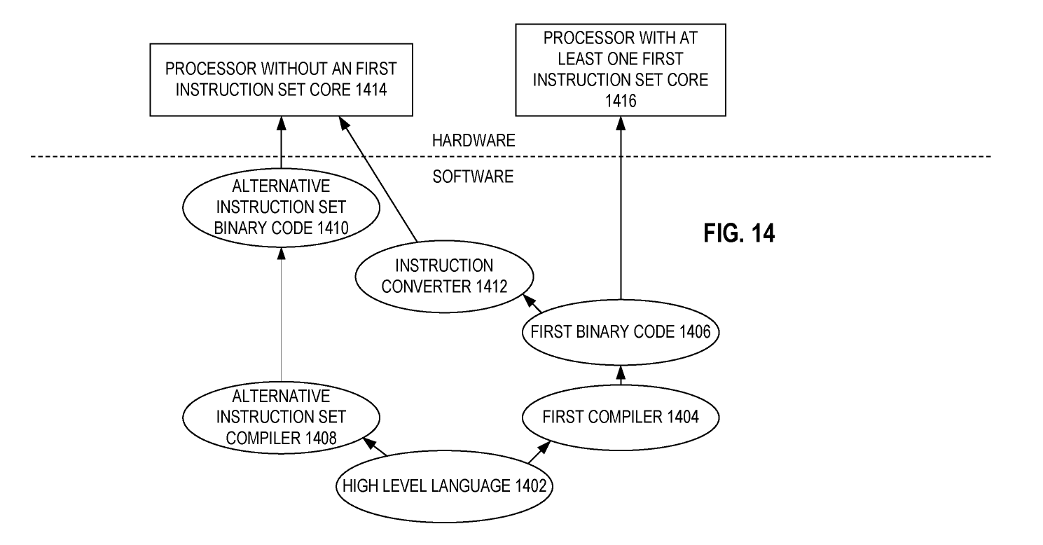

FIG. 14 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 14 shows a program in a high level language 1402 may be compiled using an first compiler 1404 to generate a first binary code (e.g., x86) 1406 that may be natively executed by a processor with at least one first instruction set core 1416. In some embodiments, the processor with at least one first instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The first compiler 1404 represents a compiler that is operable to generate binary code of the first instruction set 1406 (e.g., object code) that can, with or without additional linkage processing, be executed on the processor with at least one first instruction set core 1416. Similarly, FIG. 14 shows the program in the high level language 1402 may be compiled using an alternative instruction set compiler 1408 to generate alternative instruction set binary code 1410 that may be natively executed by a processor without at least one first instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the first binary code 1406 into code that may be natively executed by the processor without an first instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have a first instruction set processor or core to execute the first binary code 1406.

Examples of embodiments detailed herein are as follows:

### Example 1

An apparatus comprising: instruction execution circuitry to execute a decoded instruction having at least one operand utilizing half-precision floating point data; and a register to store control information about the at least one operand utilizing half-precision floating point data, wherein the control information is to dictate when underflowing operations of execution of the instruction are to be flushed to zero and when denormal inputs of the instruction are to be zeroed.

### Example 2

The apparatus of example 1, wherein the register is a control and status register.

### Example 3

The apparatus of any of examples 1-2, wherein bit position 18 of the register to store control information is used to indicate when denormal inputs of the instruction are to be zeroed.

### Example 4

The apparatus of any of examples 1-3, wherein bit position 19 of the register to store control information is used to indicate when underflowing operations of execution of the instruction are to be flushed to zero.

### Example 5

The apparatus of any of examples 1-2, wherein bit position 19 of the register to store control information is used to indicate when denormal inputs of the instruction are to be zeroed.

### Example 6

The apparatus of any of examples 1-3, wherein bit position 18 of the register to store control information is used to indicate when underflowing operations of execution of the instruction are to be flushed to zero.

### Example 7

The apparatus of any of examples 1-6, wherein the decoded instruction is a computational instruction.

### Example 8

The apparatus of any of examples 1-7, wherein the register is read by floating-point execution units of the instruction execution circuitry.

### Example 9

The apparatus of any of examples 1-8, wherein the register is further to store indications of: exceptions that have been detected including precision, underflow, overflow, divide-by-zero, denormal, and invalid operation; exception type masks including invalid operation, denormal operation, divide-by-zero mask, overflow, underflow, and precision); rounding control; and denormals-are-zeros and flush-to-zeros for non-half-precision floating-point data.

### Example 10

A method comprising: decoding an instruction having at least one operand utilizing half-precision floating point data; and executing the decoded instruction according to control information about the at least one operand utilizing half-precision floating point data, wherein the control information is to dictate when underflowing operations of execution of the instruction are to be flushed to zero and when denormal inputs of the instruction are to be zeroed.

### Example 11

The method of example 10, wherein the register is a control and status register.

### Example 12

The method of any of examples 10-11, wherein bit position 18 of the register to store control information is used to indicate when denormal inputs of the instruction are to be zeroed.

### Example 13

The method of any of examples 10-12, wherein bit position 19 of the register to store control information is used to indicate when underflowing operations of execution of the instruction are to be flushed to zero.

### Example 14

The method of any of examples 10-11, wherein bit position 19 of the register to store control information is used to indicate when denormal inputs of the instruction are to be zeroed.

### Example 15

The method of any of examples 10-12, wherein bit position 18 of the register to store control information is used to indicate when underflowing operations of execution of the instruction are to be flushed to zero.

### Example 16

The method of any of examples 10-15, wherein the decoded instruction is a computational instruction.

### Example 17

The method of any of examples 10-16, wherein the register is read by floating-point execution units of instruction execution circuitry.

### Example 18

The method of any of examples 10-17, wherein the register is further to store indications of: exceptions that have been detected including precision, underflow, overflow, divide-by-zero, denormal, and invalid operation; and exception type masks including invalid operation, denormal operation, divide-by-zero mask, overflow, underflow, and precision); rounding control; and denormals-are-zeros and flush-to-zeros for non-half-precision floating-point data.

### Example 19

A non-transitory machine-readable medium storing an occurrence of an instruction, wherein upon encountering the instruction a hardware processor to perform a method comprising: decoding the instruction having at least one operand utilizing half-precision floating point data; and executing the decoded instruction according to control information about the at least one operand utilizing half-precision floating point data, wherein the control information is to dictate when underflowing operations of execution of the instruction are to be flushed to zero and when denormal inputs of the instruction are to be zeroed.

### Example 20

The non-transitory machine-readable medium of example 19, wherein the register is a control and status register.

### Example 21

The non-transitory machine-readable medium of any of examples 19-20, wherein bit position 18 of the register to store control information is used to indicate when denormal inputs of the instruction are to be zeroed.

### Example 22

The non-transitory machine-readable medium of any of examples 19-21, wherein bit position 19 of the register to store control information is used to indicate when underflowing operations of execution of the instruction are to be flushed to zero.

### Example 23

The non-transitory machine-readable medium of any of examples 19-22, wherein the decoded instruction is a computational instruction.

### Example 24

The non-transitory machine-readable medium of any of examples 19-23, wherein the register is read by floating-point execution units of instruction execution circuitry.

### Example 25

The non-transitory machine-readable medium of any of examples 19-24, wherein the register is further to store indications of: exceptions that have been detected including precision, underflow, overflow, divide-by-zero, denormal, and invalid operation; exception type masks including invalid operation, denormal operation, divide-by-zero mask, overflow, underflow, and precision); rounding control; and denormals-are-zeros and flush-to-zeros for non-half-precision floating-point data.

We claim:

1. An apparatus comprising:
instruction execution circuitry to execute a decoded instruction having at least one operand utilizing half-precision floating point data; and
a register to store control information about the at least one operand utilizing half-precision floating point data, wherein the control information is to dictate when underflowing operations of execution of the instruction are to be flushed to zero and when denormal inputs of the instruction are to be zeroed.

2. The apparatus of claim 1, wherein the register is a control and status register.

3. The apparatus of any of claims 1-2, wherein bit position 18 of the register to store control information is used to indicate when denormal inputs of the instruction are to be zeroed.

4. The apparatus of any of claims 1-3, wherein bit position 19 of the register to store control information is used to indicate when underflowing operations of execution of the instruction are to be flushed to zero.

5. The apparatus of any of claims 1-2, wherein bit position 19 of the register to store control information is used to indicate when denormal inputs of the instruction are to be zeroed.

6. The apparatus of any of claims 1-3, wherein bit position 18 of the register to store control information is used to indicate when underflowing operations of execution of the instruction are to be flushed to zero.

7. The apparatus of any of claims 1-6, wherein the decoded instruction is a computational instruction.

8. The apparatus of any of claims 1-7, wherein the register is read by floating-point execution units of the instruction execution circuitry.

9. The apparatus of any of claims 1-8, wherein the register is further to store indications of:
exceptions that have been detected including precision, underflow, overflow, divide-by-zero, denormal, and invalid operation;
exception type masks including invalid operation, denormal operation, divide-by-zero mask, overflow, underflow, and precision);
rounding control; and
denormals-are-zeros and flush-to-zeros for non-half-precision floating-point data.

10. A method comprising:
decoding an instruction having at least one operand utilizing half-precision floating point data; and
executing the decoded instruction according to control information about the at least one operand utilizing half-precision floating point data, wherein the control information is to dictate when underflowing operations of execution of the instruction are to be flushed to zero and when denormal inputs of the instruction are to be zeroed.

11. The method of claim 10, wherein the register is a control and status register.

12. The method of any of claims 10-11, wherein bit position 18 of the register to store control information is used to indicate when denormal inputs of the instruction are to be zeroed.

13. The method of any of claims 10-12, wherein bit position 19 of the register to store control information is used to indicate when underflowing operations of execution of the instruction are to be flushed to zero.

14. The method of any of claims 10-11, wherein bit position 19 of the register to store control information is used to indicate when denormal inputs of the instruction are to be zeroed.

15. The method of any of claims 10-12, wherein bit position 18 of the register to store control information is used to indicate when underflowing operations of execution of the instruction are to be flushed to zero.

16. The method of any of claims 10-15, wherein the decoded instruction is a computational instruction.

17. The method of any of claims 10-16, wherein the register is read by floating-point execution units of instruction execution circuitry.

18. The method of any of claims 10-17, wherein the register is further to store indications of:
exceptions that have been detected including precision, underflow, overflow, divide-by-zero, denormal, and invalid operation;
exception type masks including invalid operation, denormal operation, divide-by-zero mask, overflow, underflow, and precision);
rounding control; and
denormals-are-zeros and flush-to-zeros for non-half-precision floating-point data.

19. A non-transitory machine-readable medium storing an occurrence of an instruction, wherein upon encountering the instruction a hardware processor to perform a method comprising:
decoding the instruction having at least one operand utilizing half-precision floating point data; and
executing the decoded instruction according to control information about the at least one operand utilizing half-precision floating point data, wherein the control information is to dictate when underflowing operations of execution of the instruction are to be flushed to zero and when denormal inputs of the instruction are to be zeroed.

20. The non-transitory machine-readable medium of claim 19, wherein the register is a control and status register.

21. The non-transitory machine-readable medium of any of claims 19-20, wherein bit position 18 of the register to store control information is used to indicate when denormal inputs of the instruction are to be zeroed.

22. The non-transitory machine-readable medium of any of claims 19-21, wherein bit position 19 of the register to store control information is used to indicate when underflowing operations of execution of the instruction are to be flushed to zero.

23. The non-transitory machine-readable medium of any of claims 19-22, wherein the decoded instruction is a computational instruction.

24. The non-transitory machine-readable medium of any of claims 19-23, wherein the register is read by floating-point execution units of instruction execution circuitry.

25. The non-transitory machine-readable medium of any of claims 19-24, wherein the register is further to store indications of:
exceptions that have been detected including precision, underflow, overflow, divide-by-zero, denormal, and invalid operation;
exception type masks including invalid operation, denormal operation, divide-by-zero mask, overflow, underflow, and precision);
rounding control; and
denormals-are-zeros and flush-to-zeros for non-half-precision floating-point data.
